(19) United States
(12) Patent Application Publication
(10) Pub. No.: US 2011/0173968 A1
(43) Pub. Date: Jul. 21, 2011

(54) Appratus generating electricity to marine vehicle

(76) Inventor: Ned M. Ahdoot, (US)

(21) Appl. No.: 12/657,171

(22) Filed: Jan. 15, 2010

(51) Int. Cl. F03B 13/14; F16H 21/16

(52) U.S. Cl. 60/507; 74/25; 74/29

(57) ABSTRACT

An energy converter apparatus connected via a rope between a buoyant marine vessel body and to a stationary or semi stationary surface with respect to the motions of the marine vessel to convert differential motions of the vessel compared to the stationary body to useful electrical energy; a rack and pinion gear box device causing the linear motions of the buoyant vessel to an axial rotational motions, the rotation in only one direction; a ratchet wheel connected to a shaft and an electric generator.

### CROSS-REFERENCE TO RELATED APPLICATIONS

Application Ser. No. 11/788,528

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### REFERENCE TO A “MICROFICHE APPENDIX”

Not applicable.

### BACKGROUND OF THE INVENTION

### Field of the Present Disclosure

This disclosure relates generally to machines for harnessing ocean wave movement to create useful work such as the generation of electricity for marine vehicles.

William Walter Hirsch, U.S. Pat. No. 7,199,481 b2 Wave Energy Conversion Systems.

Frank Burick U.S. Pat. No. 7,365,445B2 Apparatus for converting ocean wave energy to electrical energy.

Stephen J. Sadig U.S. Pat. No. 6,812,588B1 Wave Energy Converter.

Fred Ernest Gardener U.S. Pat. No. 5,909,060 Wave Energy Transformer

Dreck Woollatt U.S. Pat. No. 5,647,730 Self-Contained Clearance Volume Adjustment Means for a Gas Compressor.

Tzong et el U.S. Pat. No. 5,186,822 Wave Powered Desalinization With Turbine Driven Pressurization.

Ernest p. Rubi U.S. Pat. No. 4,851,704 Wave Action Electricity Generation System and Method.

Don E Rainey U.S. Pat. No. 4,208,878 Ocean Tide Energy Converter.

The related art described above discloses apparatus and methods for converting water motion and weight to useful energy. However, the prior art fails to disclose the presently described energy capturing system having the ability to be adapted to convert the energy generated by movement of a marine vessel while in water. The present disclosure distinguishes over the prior art providing heretofore unknown advantages as described in the following summary.

### BRIEF SUMMARY OF THE INVENTION

This disclosure teaches certain benefits in construction and use which give rise to the objectives described below.

An energy converter apparatus connected via a rope between a buoyant marine vessel body and to a stationary or semi stationary surface with respect to the motions of the marine vessel to convert differential motions of the vessel compared to the stationary body to useful electrical energy; a rack and pinion gear box device causing the linear motions of the buoyant vessel to an axial rotational motions, the rotation in only one direction; a ratchet wheel connected to a shaft and an electric generator.

A primary objective inherent in the above described apparatus and method of use is to provide advantages not taught by the prior art.

A still further objective is to provide such a system that is fully automated in its operation.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing(s) is at least one of the best mode embodiments of the present invention In such drawing(s):

FIG. 1 is the embodiment of an smaller version of the converter to power vessels while they are anchored to convert energy from three dimensional motion of the vessel.

FIG. 2 is the detailed drawing of the apparatus for spooling of the rope in FIG. 2.

### DETAILED DESCRIPTION OF THE INVENTION

The above described drawing figures illustrate the described apparatus and its method of use in at least one of its preferred, best mode embodiment, which is further defined in detail in the following description. Those having ordinary skill in the art may be able to make alterations and modifications to what is described herein without departing from its spirit and scope. Therefore, it must be understood that what is illustrated is set forth only for the purposes of example and that it should not be taken as a limitation in the scope of the present apparatus and method of use.

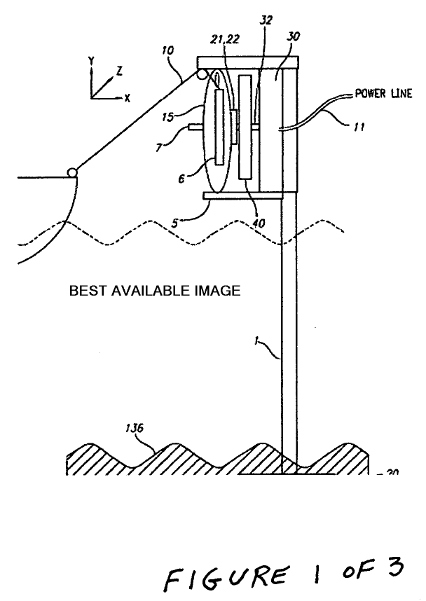

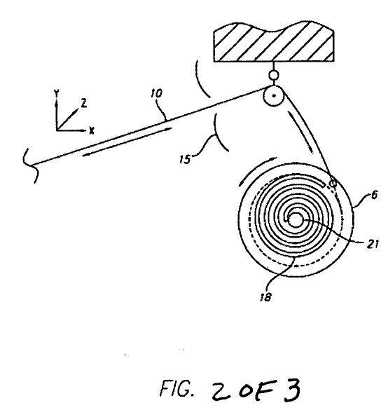

FIG. 1 is a second embodiment of the present invention to provide power to an anchored vessel such as a boat; a pulley 6 and a flexible rope 10 will provide the linear bidirectional motion of the converter. The rope connected to a buoyant body riding on top of waves or any other entity enabling reciprocating motion of the rope in three dimensional motions. The rope connected to the pulley inside a frame 15, constrained for spooling the rope and exchanging linear motion of the rope to rotational motion of the pulley. A rack and pinion 21, and 22 together with a ratchet wheel engaging the shaft 7 and the shaft 32 respectively so that the linear motion of the rope drives rotational motion of the pinion and the shaft 32 in one direction only. The ratchet wheel operates in the same manner as a coaster gear of a bicycle chain drive where, when the drive chain rotates the bicycle's drive sprocket in a direction for moving the bicycle forward, the drive sprocket transfers driving force to the bicycle's rear axle through the coaster gear, but when the chain stops moving, or even moves backward, the coaster gear disengages the drive sprocket from the bicycle's axle. The shaft 32 coaxially connected to an inertial plate 40 (fly wheel) engaged with a generator 30, thereby producing rotation of the generator 30 when the rope moves with reciprocating motion.

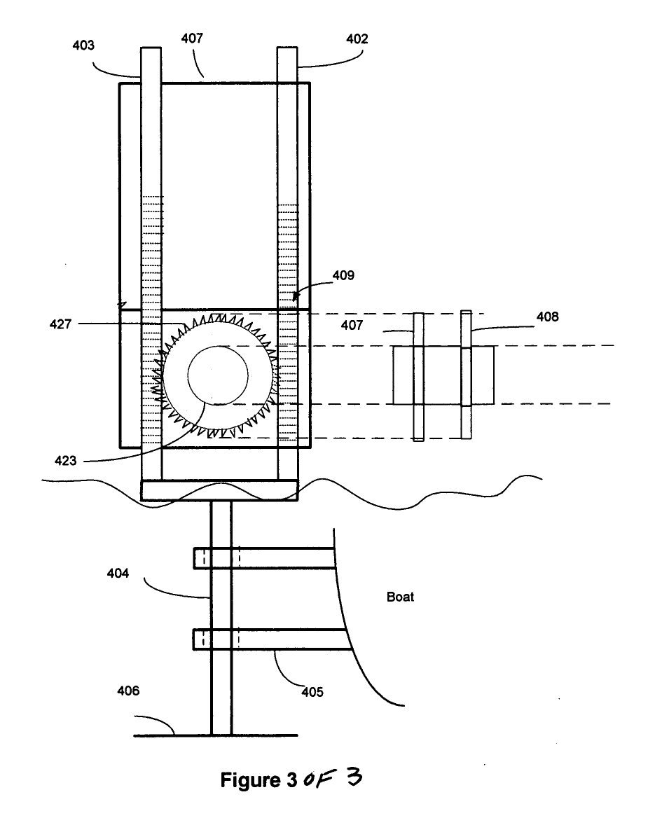

FIG. 2 is the details of the pulley connected to a shat 7 with a clock spring 18. The clock spring constrained to turn the pulley 6 in the direction of spooling the rope during the time when the force on the rope is minimal. The pulley 6 also rotates the shaft 21 when the force on the rope exceeds certain amount in a direction of un-spooling the rope, thus turning the pulley 6 and thus the motor shaft 32.

FIG. 3 is the block diagram of different embodiment of the converter to provide usable energy to a marine vehicle, when it moves up or down along the ocean waves, either stationary or moving.

The converter is positioned on a marine vehicle and the buoyant body 406 is a floating plate immersed in the water to provide the reciprocating motion; the plate is connected to a rod 404 perpendicular to the plate surface; the rod is attached to the body of the marine vehicle by mechanical means 405 to allow the rod and the plate move in the opposite direction of the up and down motion of the marine vehicle; the rod is connected to two other rods 402 and 403 with groves engaged with two rack and pinions 427 and 428; two rack and pinions are connected to the first shaft 423 such that when the plate moves in one direction, it forces the shaft to rotate in a direction and when the plate moves in an opposite direction, it forces the first shaft to move in the same direction; thus the reciprocating motion of the plate is in opposite motion with respect to the marine vehicle up and down motions, thus providing electrical energy

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

### SEQUENCE LISTING

Not applicable.

What is claimed is:

1. An apparatus for converting reciprocating mechanical motions into a rotational motion, for the purpose of converting mechanical motion energy to rotational energy for generating useable electricity; the converter being positioned fix to a permanent body with respect to ground or positioned on a movable marine vehicle, to convert reciprocating motions of bodies such as ocean water waves, or any reciprocating mechanical body to usable electricity.

2. The apparatus of claim 1, wherein the converter is comprising a flexible rope and a pulley; the rope connecting a buoyant body riding on top of waves enabling reciprocating motion of the rope; the rope connected to a pulley; the pulley providing spooling of the rope and exchanging linear motion of the rope to rotational motion of the first shaft; a rack and pinion engaging the first and a second shafts respectively; the rack connected to the first shaft; the pinion mounted on a ratchet wheel thereby being driven by the rack during linear displacement of the rope in one direction only; the second shaft coaxially connected to a flywheel engaged with a generator, thereby producing rotation of the generator when the rope moves with reciprocating motion so that the linear motion of the rope drives rotational motion of generator.

3. The apparatus of claim 1 wherein the pulley is connected to the first shaft with a clock spring, the clock spring constrained to turn the pulley in the direction of spooling the rope during the time when the force on the rope is minimal, and rotate the first shaft when the force on the rope exceeds certain amount.

4. The apparatus of claim 1 wherein the flywheel is consisting a hollow circular tube in which the area within the tube is divided into separate sections; each section filled with liquid to provide the mass necessary to store inertial energy caused by rotational motion of the flywheel.

5. The apparatus of claim one wherein the buoyant body is an inflatable raft in which the bottom of the raft is connected to the ground with a adjustable rope and an anchor; the side of the raft facing the waves is supplied with overhang pouches at an angle with respect to the bottom of the raft, such that a wave in horizontal motion would push the overhang pouch in its direction of motion and thus reciprocating motion of the rope connected to the converter.

6. The apparatus of claim one wherein the converter is positioned at the top of a pole; the buoyant body is a raft whereby the raft is guided up and down in the direction of vertical pole providing reciprocating motion of the rope; the rope connected to the pulley; the weight of the raft is pushed up by the rise of the water wave, and gets pushed down by its weight, the pulley forces the rotation of first and second shaft only in one direction only, thus the downward motion of the raft provides the potential energy that is converted to electricity.

7. The apparatus of claim one wherein the converter is positioned on a marine vehicle; the buoyant body is a floating plate immersed in the water to provide the reciprocating motion; the plate is connected to a rod perpendicular to the plate surface; the rod is attached to the body of the marine vehicle by mechanical means to allow the rod and the plate move in the opposite direction of the up and down motion of the marine vehicle; the rod is connected to two other rods with groves engaged with two rack and pinions; two rack and pinions are connected to the first shaft such that when the plate moves in one direction, it forces the shaft to rotate in a direction and when the plate moves in an opposite direction, it forces the first shaft to move in the same direction; thus the reciprocating motion of the plate is in opposite motion with respect to the marine vehicle up and down motions, thus providing electrical energy.
